(19) United States
(12) Patent Application Publication
(10) Pub. No.: US 2026/0175256 A1
(43) Pub. Date: Jun. 25, 2026

(54) METHOD FOR PRINTING SHEETS OF WOOD VENEER BY REPLICATING THE DISTINCT CHARACTER OF THE WOOD SPECIES OF ORIGIN

(71) Applicants: Chantal Parisette-Haynes, Lexington, NC (US); Sabrina Margarete Parisette-Herzog, Lexington, NC (US)

(72) Inventors: Chantal Parisette-Haynes, Lexington, NC (US); Sabrina Margarete Parisette-Herzog, Lexington, NC (US)

(21) Appl. No.: 19/430,816

(22) Filed: Dec. 23, 2025

Related U.S. Application Data
(60) Provisional application No. 63/738,174, filed on Dec. 23, 2024.

(51) Int. Cl. B05D 5/06; B05D 7/06

(52) U.S. Cl. CPC B05D 5/061; B05D 7/06

(57) ABSTRACT

A method for producing printed wood veneer sheets comprises capturing high-resolution digital images of source wood veneer using polarized lighting and a digital camera with a polarizing filter; digitally processing and aligning the images to create a seamless composite image with enhanced color and grain detail; and printing the composite image directly onto a natural wood veneer substrate using a large-format UV flatbed printer with UV-curable inks. The method enables replication of rare, endangered, or extinct wood species on sustainable substrates while preserving the tactile qualities of natural wood and achieving superior visual fidelity. The printed veneer sheets may be used in furniture, cabinetry, architectural millwork, and other applications.

### CROSS-REFERENCE TO RELATED APPLICATION

This application claims the benefit of priority to U.S. Provisional Patent Application No. 63/738,174, filed Dec. 23, 2024, entitled “METHOD FOR PRINTING SHEETS OF WOOD VENEER BY REPLICATING THE DISTINCT CHARACTER OF THE WOOD SPECIES OF ORIGIN,” the entire disclosure of which is hereby incorporated by reference herein.

### FIELD OF THE INVENTION

The present invention relates generally to methods and systems for printing wood veneer substrates. More particularly, the invention relates to a method for replicating the distinct visual and tactile character of natural wood species by capturing high-resolution images of wood veneer and printing those images onto natural wood veneer substrates using digital processing and large-format UV printing technology.

### BACKGROUND OF THE INVENTION

Wood veneer has been used for centuries in furniture, cabinetry, architectural millwork, automotive interiors, and decorative applications. Natural wood veneer provides both aesthetic appeal and a distinctive tactile quality that distinguishes it from synthetic materials. However, certain wood species have become rare, endangered, or subject to regulatory restrictions due to over-harvesting, habitat loss, or international trade limitations. Examples include Brazilian rosewood, Cuban mahogany, and various exotic tropical hardwoods.

Traditional methods of producing decorative wood surfaces have included the use of printed laminates. These laminates typically comprise a photograph or printed representation of wood grain that is applied to a paper or plastic substrate. While printed laminates can reproduce the visual appearance of wood to some degree, they lack the natural texture, depth, and tactile qualities of genuine wood veneer. Furthermore, conventional laminates exhibit inferior image fidelity and do not provide the authentic feel that is desirable in high-end applications.

Some attempts have been made to apply printed images to wood substrates, but these efforts have not adequately addressed the challenges of capturing the full visual character of rare wood species, processing high-resolution images to preserve grain detail and color accuracy, and printing directly onto natural wood veneer in a manner that maintains the substrate's inherent qualities while achieving photorealistic results.

There exists a need in the art for a method and system that can reproduce the visual characteristics of natural wood veneer, including rare, endangered, or otherwise restricted species, in a sustainable, repeatable, and industrially scalable manner. Such a method would enable manufacturers and designers to achieve the aesthetic appearance of exotic or unavailable wood species while using sustainable and readily available wood substrates.

Additionally, there is a need for a printed wood veneer product that preserves the tactile qualities of natural wood while providing superior image fidelity, repeatability across production runs, and the ability to incorporate design modifications not achievable with natural veneer alone.

### SUMMARY OF THE INVENTION

The present invention provides a method, system, and product for replicating the distinct character of wood veneer species using high-resolution imaging, digital processing, and direct printing onto natural wood veneer substrates.

In one aspect, the invention comprises a method for producing printed wood veneer sheets that replicate the appearance of a source wood species. The method generally includes the steps of: preparing a wood veneer substrate; imaging a source wood veneer using high-resolution digital photography with polarizing filters to reduce glare and enhance grain detail; digitally processing the captured images to correct distortions, align multiple images, and adjust visual characteristics such as color, lighting, and grain definition; converting the processed images into a raster graphics format suitable for fine-tuning and enhancement; and printing the final processed image directly onto the prepared wood veneer substrate using a large-format UV flatbed printer with UV-curable inks.

The resulting printed wood veneer sheets replicate the appearance of the source wood species—including restricted, endangered, or extinct woods—while maintaining the natural tactile qualities of the substrate wood. The printed veneer may be used in furniture, walls, flooring, cabinets, countertops, art pieces, automobiles, boats, aircraft interiors, and other applications where natural wood veneer is traditionally employed.

Advantages of the invention include the ability to replicate rare or restricted wood species without ecological harm, to provide repeatability and uniformity across production runs, to maintain the tactile feel of natural wood while achieving superior visual fidelity, and to enable design modifications such as digital inlays, logos, and ornamental features that are not possible with natural veneer alone.

Other aspects, features, and advantages of the present invention will become apparent from the following detailed description when taken in conjunction with the accompanying drawings.

### BRIEF DESCRIPTION OF THE DRAWINGS

The invention will be better understood and features, aspects, and advantages other than those set forth above will become apparent when consideration is given to the following detailed description thereof. Such detailed description makes reference to the accompanying drawings, wherein:

FIG. 1 is a flowchart illustrating the setup components of the imaging system according to one embodiment of the present invention, including light setup, camera setup, and belt setup configurations;

FIG. 2 is a flowchart depicting the imaging and digital processing procedure according to one embodiment of the present invention, illustrating the steps from interval shooting through image alignment, layer masking, and sizing;

FIG. 3 is a photographic representation of an exemplary printed wood veneer sheet produced according to the method of the present invention; and

FIG. 4 is a photographic representation of another exemplary printed wood veneer sheet produced according to the method of the present invention.

While the invention is susceptible to various modifications and alternative forms, specific embodiments thereof have been shown by way of example in the drawings and will herein be described in detail. It should be understood, however, that it is not intended to limit the invention to the particular forms disclosed, but on the contrary, the intention is to cover all modifications, equivalents, and alternatives falling within the spirit and scope of the invention.

### DETAILED DESCRIPTION OF THE INVENTION

The present invention relates to methods and systems for producing printed wood veneer sheets that replicate the distinct visual and tactile character of natural wood species. The following detailed description illustrates the invention by way of example, not by way of limitation. The description clearly enables one skilled in the art to make and use the invention, discloses several embodiments, adaptations, variations, alternatives, and uses of the invention, including what is presently believed to be the best mode of carrying out the invention.

### Overview

The method of the present invention generally comprises five principal stages: (1) preparation of the wood veneer substrate; (2) high-resolution imaging of source wood veneer; (3) digital processing of captured images; (4) raster graphics adjustment and enhancement; and (5) direct printing onto the prepared wood veneer substrate. Each of these stages will be described in detail below with reference to the accompanying drawings.

### 1. Preparation of Wood Veneer Substrate

The substrate upon which the final image will be printed comprises natural wood veneer. Wood veneer is typically produced by slicing logs into thin sheets, with thickness ranging from about 0.2 mm to about 2.0 mm, though other thicknesses may be employed depending on the specific application.

In one embodiment, the substrate veneer is selected from readily available, sustainable wood species such as poplar, maple, birch, or other light-colored hardwoods. The substrate may be optionally treated to achieve a desired base color or tone. For example, the veneer may be bleached to create a lighter, more neutral base that better receives printed color. Alternatively, the substrate may be dyed or stained to provide a tinted base that enhances certain color characteristics of the final printed image.

Individual veneer sheets may be spliced together to form larger panels. The splicing may be accomplished using various matching techniques known in the art, including slip-match techniques (wherein sequential sheets are joined side-by-side in the order they were sliced) or book-match techniques (wherein alternating sheets are flipped to create a mirrored grain pattern). The assembled veneer panels are typically mounted on a paper backing substrate to provide dimensional stability during subsequent processing and handling.

The prepared veneer substrate is dimensioned according to the requirements of the printing equipment and the intended final application. In one embodiment, panels may be prepared in standard sizes such as 4 feet by 8 feet, though custom dimensions may be employed as needed.

### 2. High-Resolution Imaging of Source Wood Veneer

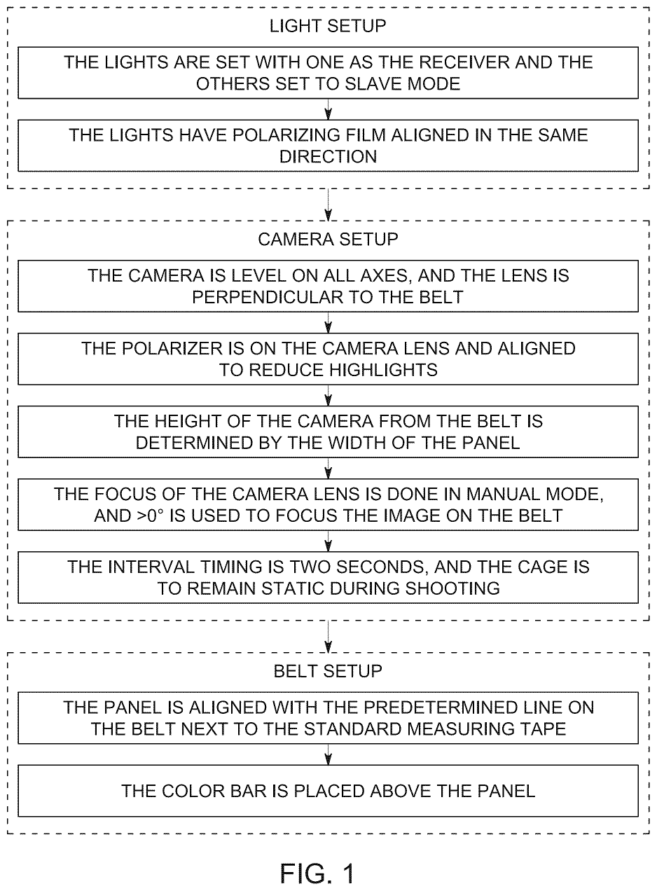

Referring now to FIG. 1, the imaging stage involves capturing high-resolution digital photographs of source wood veneer specimens that exhibit the desired visual characteristics to be replicated. The imaging system comprises several key components as described below.

Light Setup: The imaging system employs multiple light sources positioned to provide uniform illumination of the source veneer specimen. In one embodiment, the lights comprise electronic flash units or continuous LED lighting panels. One light is configured as a receiver (master) unit, while the others are set to slave mode to provide synchronized illumination.

A distinguishing feature of the imaging system is the use of polarizing film applied to each light source. The polarizing film on each light is aligned in the same direction (unidirectionally aligned) to create polarized light that reduces specular reflections and glare from the veneer surface. This polarization enhances the visibility of grain patterns and reduces unwanted highlights that would otherwise obscure fine details.

Camera Setup: The imaging system employs a high-resolution digital camera, preferably having a resolution of at least 50 megapixels, though cameras of higher or lower resolution may be employed depending on the desired image quality and final print size. The camera is mounted on a stable support structure, such as a tripod or overhead gantry, and is positioned such that the lens is perpendicular to the surface of the veneer specimen.

The camera is leveled on all axes to eliminate perspective distortion. A polarizing lens filter is attached to the camera lens and is aligned (rotated) to reduce highlights and reflections from the veneer surface. The interaction between the polarized light sources and the polarizing lens filter substantially eliminates glare and enhances the capture of subtle grain details and color variations.

The camera lens is manually focused on the veneer specimen, with the focus optimized for maximum sharpness. The height of the camera from the surface being imaged is determined by the width of the veneer panel and the field of view of the lens, such that the entire width of the panel can be captured in a single frame or in a series of overlapping frames.

Belt Setup and Imaging Procedure: In one embodiment, the source veneer panel is positioned on a motorized conveyor belt or moving platform. The panel is aligned with a predetermined reference line on the belt, adjacent to which is positioned a measuring tape or scale to facilitate subsequent image alignment and dimensioning. A color calibration bar or color reference chart may be placed above or adjacent to the panel to provide a reference for color correction in subsequent processing stages.

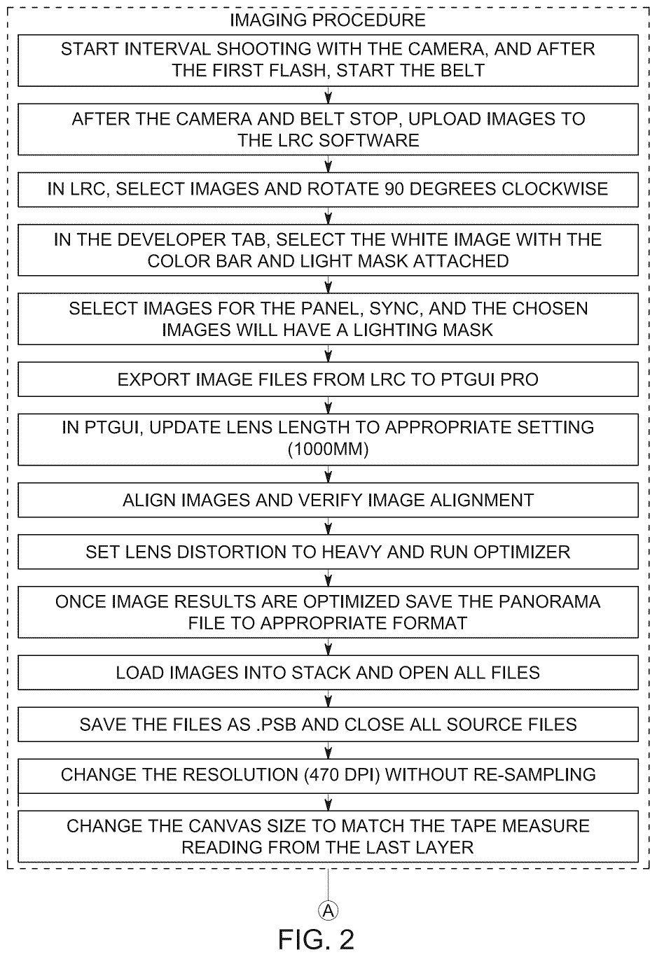

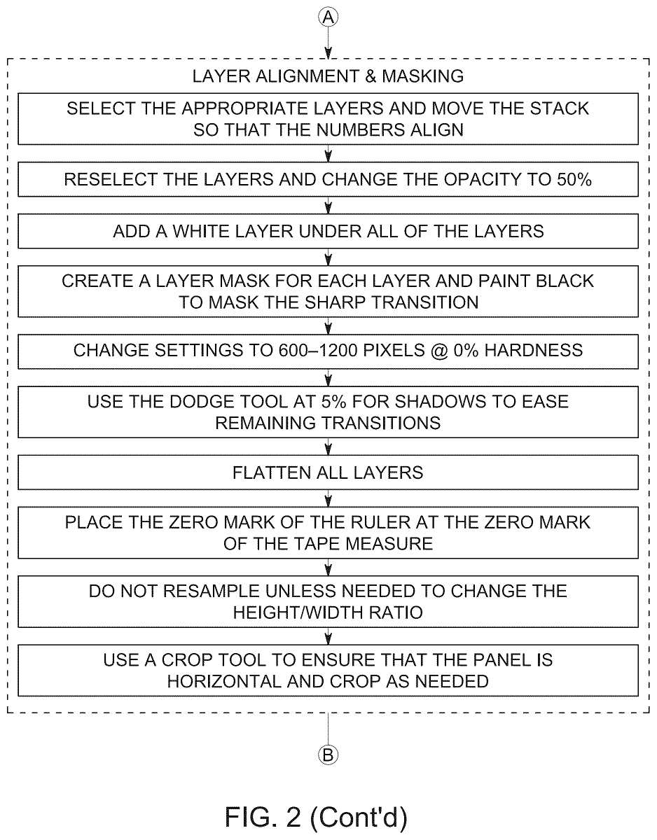

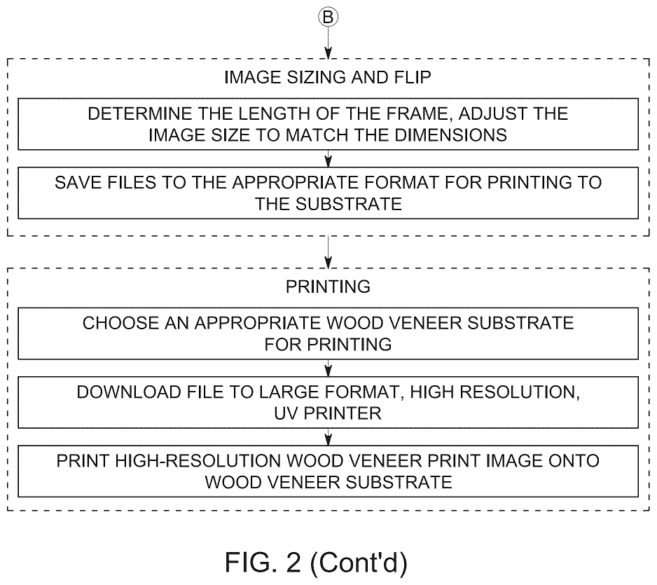

Referring now to FIG. 2, the imaging procedure is initiated by programming the camera to operate in interval shooting mode, wherein the camera automatically captures images at predetermined time intervals (e.g., every two seconds). The camera support structure (cage) remains static during shooting to maintain consistent perspective and focus.

After the first flash or exposure, the motorized belt is started, causing the veneer panel to move past the camera's field of view. The camera continues to capture images at the predetermined intervals, resulting in a series of overlapping photographs that collectively span the entire length of the veneer panel. This technique enables the imaging of veneer panels that are longer than the camera's field of view and ensures complete coverage of the specimen.

After the camera and belt have completed the imaging sequence, the captured images are uploaded to a computing device for digital processing.

### 3. Digital Processing of Captured Images

The digital processing stage transforms the series of captured photographs into a single, seamless, high-resolution representation of the source veneer. This stage may be performed using various image processing software applications, including but not limited to Adobe Lightroom (LRC), PTGui Pro, Adobe Photoshop, and other similar tools.

Initial Processing in Lightroom (LRC): The uploaded images are first imported into Adobe Lightroom or a similar raw image processing application. In Lightroom, the images are rotated 90 degrees clockwise (or as needed) to achieve the correct orientation.

One of the initial images—typically a reference image that includes the color calibration bar—is selected for color correction. A lighting mask is applied to this reference image to correct for any uneven illumination or vignetting. The settings and corrections applied to this reference image are then synchronized to all other images in the sequence, ensuring consistent color, exposure, and tonal characteristics across the entire series.

The processed images are then exported from Lightroom in a suitable file format (e.g., TIFF or high-quality JPEG) for further processing.

Image Alignment in PTGui Pro: The exported images are imported into PTGui Pro or a similar panoramic image stitching application. PTGui Pro is configured with the appropriate lens parameters, including the effective focal length (e.g., 1000 mm equivalent), to accurately model the optical characteristics of the camera system.

The software analyzes the overlapping regions of adjacent images and identifies control points that correspond to the same physical locations in the veneer specimen. The images are aligned based on these control points to create a seamless composite.

Lens distortion correction is applied—often set to a “heavy” correction profile—to compensate for barrel distortion, pincushion distortion, or other optical aberrations introduced by the camera lens. The software's optimizer is run to refine the alignment and minimize visible seams or discontinuities between adjacent images.

Once the alignment is optimized, the composite panorama is saved in an appropriate file format that preserves the full resolution and color depth of the image.

Layer Alignment and Masking in Photoshop: The aligned images are loaded into Adobe Photoshop or a similar layer-based image editing application. In one embodiment, the images are loaded as a stack of layers, with each layer corresponding to one of the captured photographs.

The resolution of the composite image is adjusted to match the intended print resolution, typically in the range of 300 to 600 dots per inch (DPI). In one embodiment, a resolution of 470 DPI is employed. The canvas size is adjusted to match the physical dimensions of the veneer panel, as indicated by the measuring tape visible in the captured images.

The layers are manually or automatically aligned such that the reference marks (e.g., the numbers on the measuring tape) align across adjacent layers. The opacity of each layer is temporarily reduced (e.g., to 50%) to facilitate visual inspection of the alignment.

A white background layer is added beneath all image layers to provide a neutral base. Layer masks are created for each image layer, and the masks are painted (e.g., with a soft black brush) to blend the transition regions between adjacent images. This masking process eliminates visible seams and creates smooth transitions where images overlap.

The brush settings for masking are typically configured with a large diameter (e.g., 600 to 1200 pixels) and 0% hardness to create gradual, feathered transitions. A dodge tool or similar tonal adjustment tool may be applied at low opacity (e.g., 5%) to further ease transitions and eliminate any remaining shadow artifacts or tonal discontinuities.

After the masking and blending operations are complete, all layers are flattened into a single composite image. The zero mark of a digital ruler tool is aligned with the zero mark of the measuring tape in the image to establish accurate dimensioning.

The image is cropped as needed to remove extraneous regions and to ensure that the panel edges are perfectly horizontal and vertical. If necessary, the image dimensions are adjusted (with or without resampling) to match the final desired output size.

### 4. Raster Graphics Adjustment and Enhancement

The processed composite image is converted into a raster graphics format suitable for fine-tuning and enhancement. This stage may be performed within Adobe Photoshop or a similar raster graphics editing application.

Adjustments that may be applied during this stage include:

Color Correction: Fine-tuning of hue, saturation, brightness, and contrast to achieve accurate color reproduction or to create desired aesthetic effects.

Grain Enhancement: Sharpening or local contrast enhancement to accentuate the natural grain patterns and texture of the wood.

Imperfection Removal: Digital retouching to remove knots, splits, mineral streaks, or other natural imperfections that may be undesirable in the final product. Alternatively, certain imperfections may be retained or enhanced if they contribute to the desired aesthetic.

Addition of Digital Inlays, Logos, or Ornamental Features: Custom graphics, text, logos, or decorative elements may be digitally composited into the wood grain image. This capability enables design customization that would be difficult or impossible to achieve with natural veneer alone.

The final processed image is saved in a high-resolution raster format suitable for printing, such as TIFF, PNG, or high-quality JPEG.

### 5. Printing Onto Wood Veneer Substrate

Referring again to FIG. 2, the final stage of the method comprises printing the processed image directly onto the prepared wood veneer substrate. The printing is performed using a large-format UV flatbed printer equipped with UV-curable inks.

The prepared veneer substrate (as described in Section 1 above) is positioned on the printing bed of the UV flatbed printer. The substrate is secured to prevent movement during printing.

The digital image file is downloaded to the printer's control system, where it may be further processed by raster image processing (RIP) software to optimize color management, halftone patterns, and ink deposition.

The printer deposits UV-curable ink onto the veneer surface in multiple passes, building up the image with precise droplet placement. In one embodiment, the printer employs CMYK (cyan, magenta, yellow, black) inks, optionally supplemented with additional colors such as light cyan, light magenta, white, or clear coating to extend the color gamut and enhance image depth.

An adhesion promoter or primer may be applied to the veneer surface prior to ink deposition to enhance ink adhesion and prevent bleeding or feathering on the porous wood substrate. Alternatively, the UV-curable inks may be formulated with adhesion-enhancing additives suitable for wood substrates.

Multiple layers of ink may be applied to enhance color saturation, depth, and realism. After each pass or after the completion of all printing passes, the printed ink is cured by exposure to ultraviolet (UV) light emitted by UV lamps integrated into the printer. The UV curing process causes the liquid ink to polymerize and harden, resulting in a durable, scratch-resistant printed surface.

The printed veneer sheet is removed from the printer and allowed to cool or rest as needed. The printed veneer may be subjected to additional finishing processes, such as application of a protective topcoat, lamination to a backing material, or trimming to final dimensions.

### Resulting Product and Applications

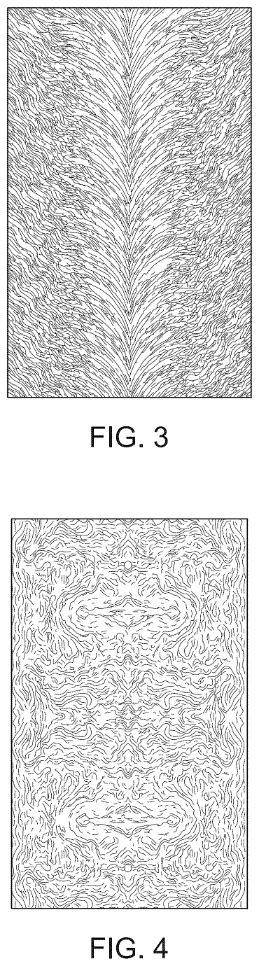

Referring now to FIGS. 3 and 4, the printed wood veneer sheets produced by the method of the present invention exhibit high-fidelity replication of the visual characteristics of the source wood species, including grain patterns, color variations, figure (such as quilting, fiddleback, or burl patterns), and other distinctive features. Importantly, the printed veneer retains the natural tactile qualities of wood, including surface texture and warmth to the touch, which distinguishes it from synthetic laminates.

The printed veneer sheets may be used in a wide variety of applications, including but not limited to:

Furniture: Tabletops, cabinet doors, drawer fronts, bed frames, and decorative inlays.

Architectural Millwork: Wall panels, wainscoting, ceiling treatments, column wraps, and door faces.

Flooring: While less common, printed veneer may be incorporated into engineered flooring products.

Cabinetry and Countertops: Kitchen and bathroom cabinets, countertop surfaces, and backsplashes.

Art Pieces: Marquetry, wood mosaics, and decorative panels.

Transportation Interiors: Automotive dashboards, door panels, and trim; boat cabinetry and paneling; aircraft interior finishes.

### Advantages and Alternative Embodiments

The method of the present invention provides numerous advantages over prior art methods:

Ecological Sustainability: The method enables replication of rare, endangered, or extinct wood species without harvesting additional trees from threatened populations.

Repeatability and Uniformity: Once a digital image of a desirable wood specimen has been captured and processed, that image may be printed repeatedly onto multiple substrates, ensuring uniformity across large production runs or enabling exact matching for repair and replacement applications.

Superior Visual Fidelity: The combination of high-resolution imaging, polarization techniques, and UV printing produces images with exceptional detail, color accuracy, and depth that rival or exceed the appearance of natural veneer.

Tactile Authenticity: Unlike paper or plastic laminates, the printed product retains the natural feel, warmth, and texture of wood.

Design Flexibility: Digital processing enables modifications that are not possible with natural veneer, including color adjustments, imperfection removal, and incorporation of custom graphics or inlays.

While the detailed description above discloses specific embodiments of the invention, various modifications and alternative implementations are possible without departing from the scope of the invention. For example:
Alternative imaging equipment, including different camera models, lens configurations, or lighting systems, may be employed.
Alternative digital processing software or techniques may be used to achieve similar results in image alignment, color correction, and enhancement.
Alternative printing technologies, such as solvent-based inkjet printing, latex printing, or other digital printing methods, may be substituted for UV-curable inkjet printing.
The substrate veneer may be selected from a wide variety of wood species, and may include engineered wood products, wood composites, or other cellulose-based substrates.
The method may be adapted to print onto other substrates that provide similar tactile qualities, such as bamboo, cork, or other natural materials.

It will be appreciated that the method described herein provides a practical and commercially viable solution to the long-felt need for sustainable replication of rare and exotic wood species, while maintaining the authentic appearance and feel that is valued in high-quality woodworking and design applications.

What is claimed is:

1. A method for producing a printed wood veneer sheet, comprising:
providing a wood veneer substrate;
capturing a plurality of digital images of a source wood veneer using a digital camera equipped with a polarizing lens filter, wherein the source wood veneer is illuminated by polarized light sources;
digitally processing the plurality of digital images to create a composite image, said processing comprising aligning the plurality of digital images and blending transition regions between adjacent images;
converting the composite image into a raster graphics format; and
printing the composite image onto the wood veneer substrate using a UV flatbed printer with UV-curable inks.

2. The method of claim 1, wherein the wood veneer substrate has a thickness between about 0.2 mm and about 2.0 mm.

3. The method of claim 1, wherein the wood veneer substrate is selected from the group consisting of poplar, maple, birch, and other hardwood species.

4. The method of claim 1, further comprising treating the wood veneer substrate by bleaching, dyeing, or staining prior to printing.

5. The method of claim 1, wherein the wood veneer substrate comprises a plurality of veneer sheets spliced together using slip-match or book-match techniques.

6. The method of claim 1, wherein the digital camera has a resolution of at least 50 megapixels.

7. The method of claim 1, wherein the polarized light sources comprise a plurality of light units having unidirectionally aligned polarizing film.

8. The method of claim 1, wherein capturing the plurality of digital images comprises:
positioning the source wood veneer on a motorized conveyor belt;
configuring the digital camera to operate in interval shooting mode;
initiating image capture; and
moving the motorized conveyor belt to sequentially position different portions of the source wood veneer within a field of view of the digital camera.

9. The method of claim 1, wherein digitally processing the plurality of digital images comprises:
applying a lighting mask to at least one reference image;
synchronizing color and exposure settings across the plurality of digital images;
aligning the plurality of digital images using panoramic stitching software; and
correcting lens distortion.

10. The method of claim 9, wherein digitally processing further comprises:
loading the aligned images as layers in an image editing application;
creating layer masks for each layer; and
blending the layer masks to eliminate visible seams between adjacent images.

11. The method of claim 1, further comprising adjusting the composite image to enhance grain patterns, correct color, or add decorative elements prior to printing.

12. The method of claim 1, wherein printing the composite image comprises:
applying an adhesion promoter to the wood veneer substrate;
depositing UV-curable ink onto the wood veneer substrate; and
curing the deposited ink with ultraviolet light.

13. The method of claim 12, wherein multiple layers of UV-curable ink are applied to enhance depth and color saturation.

14. The method of claim 1, wherein the source wood veneer comprises a rare, endangered, or extinct wood species, and the printed wood veneer sheet replicates the visual appearance of said species.

15. A method for producing a printed wood veneer sheet that replicates a source wood species, comprising:
preparing a natural wood veneer substrate by selecting a veneer having a thickness between about 0.2 mm and about 2.0 mm;
imaging the source wood species by capturing a series of overlapping high-resolution digital photographs using a digital camera with a polarizing filter, wherein the source wood species is illuminated by polarized light to reduce glare;
processing the series of digital photographs by aligning the photographs to create a seamless composite image, applying color correction, and creating blended layer masks to eliminate visible seams;
enhancing the composite image by adjusting color, grain definition, and visual characteristics;
converting the enhanced composite image into a printable raster graphics format; and
printing the raster graphics image directly onto the natural wood veneer substrate using a large-format UV flatbed printer with UV-curable inks, followed by UV curing to harden the printed image.

16. The method of claim 15, wherein the natural wood veneer substrate is bleached prior to printing to provide a neutral base color.

17. The method of claim 15, wherein processing the series of digital photographs comprises using panoramic stitching software to align the photographs based on control points in overlapping regions.

18. The method of claim 15, wherein enhancing the composite image comprises adding digital inlays, logos, or ornamental features to the composite image.

19. A printed wood veneer product comprising:
a natural wood veneer substrate having a thickness between about 0.2 mm and about 2.0 mm; and
a printed image on a surface of the natural wood veneer substrate, wherein the printed image replicates the visual appearance of a source wood species and is formed from UV-cured ink printed directly onto the natural wood veneer substrate.

20. The printed wood veneer product of claim 19, wherein the source wood species comprises a rare, endangered, or extinct wood species, and wherein the printed wood veneer product retains the tactile qualities of natural wood.
